(19) United States
(12) Patent Application Publication
(10) Pub. No.: US 2025/0182336 A1
(43) Pub. Date: Jun. 5, 2025

(54) Image Difference Generation

(71) Applicant: Google LLC, Mountain View, CA (US)

(72) Inventors: Andrea Di Blas, Sunnyvale, CA (US); Yanru Li, San Diego, CA (US)

(73) Assignee: Google LLC, Mountain View, CA (US)

(21) Appl. No.: 18/842,299

(22) PCT Filed: Mar. 11, 2022
(86) PCT No.: PCT/US2022/019936

§ 371 Date: Aug. 28, 2024

(51) Int. Cl. G06T 9/00

(52) U.S. Cl. CPC G06T 9/00

(57) ABSTRACT

Methods, systems, and apparatus, for image difference generation. In some implementations, raw image data is obtained for an image. Compressed image data is obtained for the image. A decoded frame is generated from the compressed image data. Differences in pixel values between at least a portion of the raw image data and the decoded frame are computed. An image file is generated that includes both the compressed image data and a representation of the differences in pixel values.

### TECHNICAL FIELD

This disclosure relates to systems and devices for image authentication.

### BACKGROUND

Image authentication is the application of trusted image encoding and decoding to determine if a questioned image is an accurate representation of the original data captured by an imaging sensor, e.g., a camera. Image authentication can be applied to a device or a system that receives and displays an image, such as a camera application in a mobile device, a property monitoring and security device, any social media application that displays images, and so on.

Image authentication plays an important role for risk identification and fraud identification for a variety of use cases. For example, when images of a damaged car are sent to an insurance company during an insurance claim, the insurance company may need to determine whether the images of the damaged car are authentic. As another example, a bank needs to determine whether an image of a check for deposit has been tampered with. A government might want to know whether images passed around in social media are fake images that spread fake news. A user of a social media platform might want to know whether an image is authentic or overly manipulated.

Some image authentication techniques involve generating an authentication image in a specialized image format, which mainly focuses on proving that the raw image data was captured by the camera sensor. The generated authentication image can include (i) raw image data; (ii) a digital signature for a hash of the raw image data; (iii) a processed image of the raw image data in a compressed image format; and (iv) a digital signature for a hash of the processed image of the raw image data. Examples of the specialized image format include Digital NeGative image format (DNG). The provenance of images can also be established using watermarking. For example, an image can include a watermark that identifies the creator or owner of the image.

One drawback of conventional image authentication is that it can be spoofed. For example, if an image has two individual signatures for a raw image and a processed image, one of the images, together with its corresponding signature, can be maliciously modified or replaced.

In one general aspect, a method includes: obtaining raw image data for an image; obtaining processed image data for the image; generating a decoded frame from the processed image data; computing differences in pixel values between at least a portion of the raw image data and the decoded frame; and generating an image file that includes both the processed image data and a representation of the differences in pixel values.

Implementations include one or more of the following features. For example, in some implementations, generating the decoded frame from the processed image data includes: identifying a frame in the processed image data; and reconstructing a red, green, blue (RGB) frame from the frame, where the RGB frame is the decoded frame.

In some implementations, the RGB frame includes a set of color channels for each pixel in the RGB frame, and where computing differences in the pixel values includes: for each pixel in the RGB frame, identifying a color channel of the pixel that matches a color of a corresponding pixel in the at least portion of the raw image data; and for each pixel in the RGB frame, discarding the other color channels that did not match the color of the corresponding pixel in the at least portion of the raw image data such that the pixel contains a single color channel.

In some implementations, computing differences in pixel values between the at least portion of the raw image data and the decoded frame includes: identifying, for each pixel in the at least portion of the raw image data, a value for the pixel and a second value for a corresponding pixel in the decoded frame; and taking, for each pixel in the at least portion of the raw image data, a difference between the value and the second value.

In some implementations, computing differences in pixel values between the at least portion of the raw image data and the decoded frame includes: identifying a scale of the at least portion of the raw image data; and scaling the decoded frame to the scale of the at least portion of the raw image data, where identifying, for each pixel in the at least portion of the raw image data, the value for the pixel and the second value for the corresponding pixel in the decoded frame includes identifying, for each pixel in the at least portion of the raw image data, the value for the pixel and the second value for the corresponding pixel in the decoded frame after the decoded frame is scaled.

In some implementations, the value for the pixel and the second value for the corresponding pixel are values representing color intensities.

In some implementations, generating an image file that includes both the processed image data and a representation of the differences in pixel values includes encoding and compressing the differences in pixel values.

In some implementations, the representation of the differences in pixel values is the encoded and compressed differences in pixel values.

In some implementations, the differences in pixel values is a difference image, and encoding and compressing the differences in pixel values includes: partitioning the difference image into one or more macroblocks; encoding the partitioned image to generated an encoded image; and compressing the encoded image to generate an encoded and compressed image.

In some implementations, generating the image file includes generating a digital signature using the processed image data and the representation of the differences in pixel values, and the image file includes the digital signature.

Other embodiments of these aspects include corresponding systems, apparatus, and computer programs encoded on computer storage devices, configured to perform the actions of the methods. A system of one or more computers can be so configured by virtue of software, firmware, hardware, or a combination of them installed on the system that, in operation, cause the system to perform the actions. One or more computer programs can be so configured by virtue having instructions that, when executed by data processing apparatus, cause the apparatus to perform the actions.

In addition, a conventional authentication image can have a large file size because all the raw data may be included in the authentication image, in addition to the processed version of the image data.

### SUMMARY

This specification describes technologies for image authentication. The image authentication techniques described below use an output generated in an authenticated image format that includes a post-processed image and additional information that allows an image rendering device to reconstruct an earlier version of the image. For example, a system for image authentication can include a first computing device that generates the output from a compressed image such as a JPEG and an earlier or original version of the image, such as a raw image (e.g., Bayer RGGB). The output can include compressed image as well as additional information. The first computing device can transmit the output to a second computing device of the system that can reconstruct the raw image from the compressed image and the additional information in the output. The second computing device can present the reconstructed image to a user of the second computing device who, for example, can compare it to the compressed image to authenticate the image or identify changes made to the compressed image during processing.

The additional information can include differences or a representation of differences between the post-processed image and the earlier version of the image. These differences can be or represent differences in light intensity between the post-processed image and the earlier version of the image. As an example, when the earlier version of the image is raw image data, the system can first convert the post-processed image data (e.g., JPEG) to a decoded frame such as a red-green-blue (RGB) reconstructed image and proceed, for each pixel of the raw image data and corresponding pixel of the RGB reconstructed image, to calculate a value difference between a light intensity of the raw pixel and corresponding pixel of the RGB reconstructed image. Accordingly, the calculated difference can include a value for each pixel in the decoded frame. The calculated differences can be referred to or represented by a delta.

Calculating the differences can include selecting color channels of the decoded frame that correspond to pixel colors of the earlier version of the image. For example, the RGB reconstructed image can include a red, green, and blue channel for each pixel, each with its own light intensity (e.g., color intensity) value. The first computing device can determine, for each pixel of the RGB reconstructed image, which channel value to use by identifying a color of a corresponding pixel in the raw image. In more detail, if a first pixel in Bayer RGGB raw image is a green pixel, the first computing device can select the value of the green channel for a corresponding pixel in the RGB reconstructed image.

The differences can be used to reconstruct the earlier version of the image. For example, the second computing device can convert the post-processed image data (e.g., JPEG) in the output to a decoded frame such as a red-green-blue (RGB) reconstructed image and proceed to add the differences to the decoded frame to reconstruct the raw image.

The differences can be compressed and included in an output image file that also includes the post-processed image data. The output image file can be sent to a computing device configured to use the output image file to reconstruct the earlier version of the image from the differences and the post-processed image (e.g., JPEG). By compressing the differences instead of, for example, the entire earlier version of the image, more efficient compression can be achieved and the size of the output image file can be reduced. For example, it is desirable for the output image file to contain a post-processed image such as a compressed image that can be viewed by typical image viewers. However, an output image file that includes both the post-processed image and the earlier version of the image, such as a raw image, would be very large. By instead calculating the differences and including them in the output image file after compression in place of the earlier version of the image, the size of the output image file can be significantly reduced while providing the ability to still reconstruct the earlier version of the image.

As mentioned above, the earlier version of the image data used to compute the delta can be raw image data. The raw image data can, but need not, be sensor data acquired by a camera before any processing occurs. As an example, the camera can be an on-board camera of the first device or a camera of a different device that communicates with the first computing device. In some cases, raw image data means data from an earlier stage of an image processing pipeline that can be used to compute a delta. In addition, the term image data means any appropriate data that can be used to generate an image rendering, and thus includes actual image formats, as well as other binary information or intermediate representations that can be used for the same purpose.

The subject matter described in this specification can be implemented in particular embodiments so as to realize one or more of the following advantages. Rather than generating two individual signatures for raw image data and processed image data as in a conventional image authentication format, a digital signature in the authenticated image format is generated based on the full content, i.e., both the processed image data and the representation of the delta, to allow for authenticating the generated output in the authenticated image format. That is, the joint signature can ensure that authentication is based on the whole content in the generated output. The authenticated image format results in smaller file size because a representation of a delta between a decoded frame of the processed image data and the raw image data can be saved as a part of the generated output, rather than saving the entire raw image data. Therefore, compared with the conventional image authentication format, the authenticated image format reduces the cost associated with storing and transmitting the generated output in the authenticated image format.

After receiving a request to generate the raw image data from an input data in the authenticated image format, an image rendering computer can reconstruct the raw image data from the representation of the delta between the decoded frame of the processed image data and the raw image data. The image rendering computer can present the processed image data and the raw image through a user interface such that a user can compare the reconstructed raw image data with the processed image data, and the user can determine whether the input data in the authenticated image format is authentic, e.g., whether the processed image data is an authentic representation of the raw image data. In some implementations, the image rendering computer or another computer can receive the processed image data and the raw image as input and can generate, using, for example, a machine learning algorithm, a likelihood score indicating whether the processed image data is an authentic representation of the raw image data.

Moreover, raw image data taken directly from the sensor may not be the best data for image authentication for some of the use cases. In many use cases, post-processing on the raw image data can be helpful to improve the image quality of the raw image data without compromising the authenticity of the image. For example, image enhancements, e.g., denoising, motion correction, etc., can help improve the image quality. In some cases, multiple raw images can be used to create one processed image data, such as High Dynamic Range (HDR) imaging, low-light imaging, and so on. Therefore, the final post-processed image can be related to multiple raw images, instead of a single raw image. These post-processed images can still be considered as authentic images even though they are different from the raw image data. The authenticated image format can allow authentication of processed images generated from a single raw image or a sequence of multiple raw images.

In addition, the authenticated image format can include a digital certificate that includes a public key of a public-private key pair of the device that generated the input data in the authenticated image format. The image rendering computer can verify whether the device that generated the input data is trustworthy by verifying the public key in the digital certificate, e.g., by verifying the signature in the certificate with a Certification Authority (CA) public key. In some implementations, the image rendering computer can retrieve a device public key stored in a trusted server and can verify the digital signature using the retrieved device public key. This ensures that an untrusted device cannot generate an unauthorized public-private key pair and cannot claim that the unauthorized public-private key pair corresponds to another trusted device.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system for generating an output in an authenticated image format.

FIG. 2 is a diagram of an example computing device.

FIG. 3 is a diagram of an example system for rendering an image in an authenticated image format.

FIG. 4 is a flowchart of an example process for generating an output in an authenticated image format.

FIG. 5 is a flowchart of an example process for reconstructing raw image data from input data in an authenticated image format.

FIGS. 6A-6B are diagrams of an example system for generating an output in an authenticated image format and reconstructing an earlier version of an image from the output.

FIG. 7 is a diagram illustrating an example authenticated image format of an output.

FIG. 8 is a flowchart of an example process for generating an output in an authenticated image format.

Like reference numbers and designations in the various drawings indicate like components.

### DETAILED DESCRIPTION

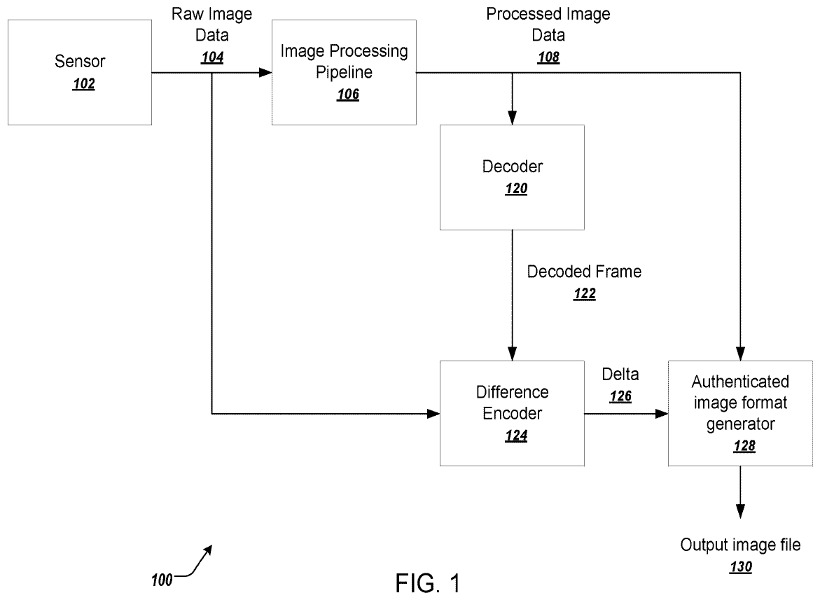

FIG. 1 is a diagram of an example system 100 for generating an output in an authenticated image format.

The system 100 includes a sensor 102, an image processing pipeline 106, a decoder 120, a difference encoder 124, and an authenticated image format generator 128.

The sensor 102 can capture raw image data 104. The sensor 102 can be a camera of the system 100, or any other kind of image capturing sensor. The raw image data 104 can include a raw image, or multiple raw images at a sequence of frames captured within a period of time. The raw image data 104 can include a color image or a grayscale image. The raw image data 104 is not processed by any image post-processing methods.

The system 100 can perform a post-processing on the raw image data 104 using an image processing pipeline 106. The image processing pipeline 106 can include a sequence of image processing steps and can generate processed image data 108 with improved image quality and or reduced file size. Each image processing step can use one or more image processing algorithms. In some implementations, the image processing pipeline 106 can include a step that can generate an enhanced image that improves the appearance of the raw image data, such as denoising, motion correction, contrast enhancement, and so on. In some implementations, the image processing pipeline 106 can include a step that generates one enhanced image from multiple raw images at multiple frames, such as HDR/HDR+imaging, low-light imaging, and so on. In some implementations, the image processing pipeline 106 can include a step that aligns the multiple raw images at multiple frames and merges the multiple raw images into a single image, and the single image can be further enhanced and compressed by other steps of the image processing pipeline 106.

In some implementations, the image processing pipeline 106 can include an encoding step that compresses the raw image data 104 or the enhanced image and generates the processed image data 108 in a compressed image format, e.g., JPEG, PNG, TIFF, and so on. The processed image data 108 can include a processed image, or other format of processed data generated from the raw image data 104. The processed image data 108 in the compressed image format can have a smaller file size than a raw image in the raw image data 104.

Some image processing pipeline 106 can generate processed image data 108 that is an authentic representation of the raw image data 104. For example, an image processing pipeline 106 can generate processed image data 108 using one or more of low-light enhancement, HDR imaging, denoising, deblurring and so on, and the processed image data 108 can still be considered an authentic representation of the raw image data 104.

However, the image processing pipeline 106 can generate processed image data 108 that would not be considered to be an authentic representation of the raw image. The image processing pipeline 106 can, for example, change the shape, size, location, or texture of an object in the image, and/or can add or remove an object in the image. For example, a fake image can be generated by a mobile application that overly modifies the content of the image, e.g., a fake image of a car to be submitted to an insurance company with modifications to the damaged portion of the car. As another example, an image can be edited by a computer software such that the processed image contains one or more objects that do not belong to the raw image, e.g., a fake image of a check for deposit to a bank with a modified bank account number.

The decoder 120 can decode the processed image data 108 and generate a decoded frame 122. The decoder 120 can be deterministic and specified. The same decoder can be used later in an image rendering computer to reconstruct the raw image from the authenticated image. The decoded frame 122 includes image data that is comparable to the format of the raw image data 104. For example, the decoded frame 122 can be in an uncompressed image format. In some implementations, the decoder 120 can be a JPEG image decoder that can generate a decoded image from a JPEG encoded image.

The difference encoder 124 can take the decoded frame 122 of the processed image data and the raw image data 104 as input, and can generate a representation of a delta 126 between the decoded frame 122 of the processed image data 108 and the raw image data 104. The difference encoder 124 can compute the delta, e.g., a difference image, by subtracting the decoded frame 122 from a raw image in the raw image data 104. The difference encoder 124 can generate a representation of the delta 126 based on a compression algorithm that measures differences between image frames. For example, the compression algorithm can be similar to a video compression algorithm, such as MPEG-2, MPEG-4 part 10/H.264, or H.265 algorithms, that measures and compresses the difference between image frames in a video. The video compression algorithm can be adapted to measure and compress the difference between the decoded frame 122 and the raw image data 104.

In some implementations, when the raw image data 104 includes two or more raw image frames, the difference encoder 124 can compare the decoded frame with a selected raw image from the multiple raw image frames. In some implementations, the difference encoder 124 can select a raw image that corresponds to a time point that is the same or closest to the time point of the decoded frame 122.

The authenticated image format generator 128 can combine the processed image data 108 and the representation of the delta 126 of the decoded frame and the raw image data into a single output image file 130 in an authenticated image format. Unlike a conventional image authentication method that saves the raw image data 104 into the output image file, the system 100 can include a much smaller, compressed representation of the delta 126 between the decoded frame 122 of the processed image data 108 and the raw image data 104 in the output image file 130. Therefore, the output image file 130 in the authenticated image format can have a smaller size than image data generated with a conventional image authentication method.

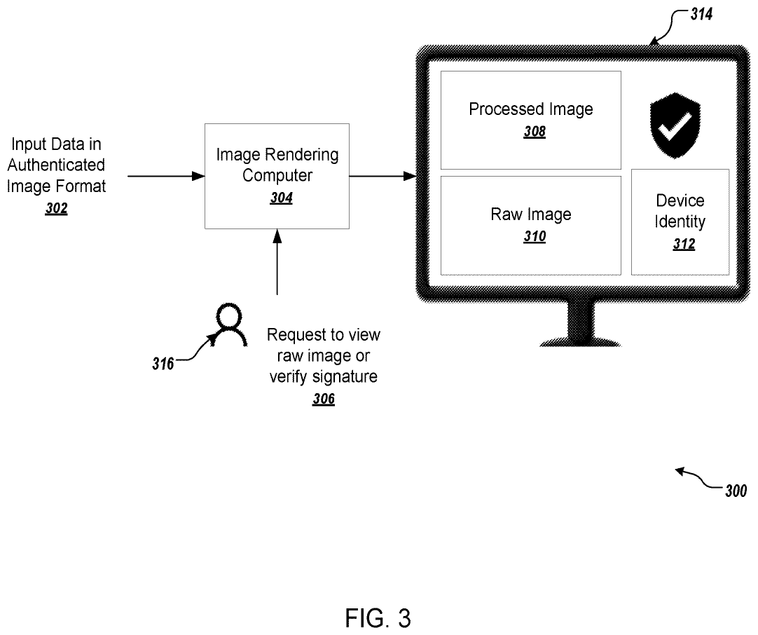

Upon request, an image rendering device can reconstruct the raw image data from the output image file 130 that is received by the image rendering device. The reconstructed raw image data can be compared with the processed image data 108 included in the output image file 130 in order to determine whether the processed image data 108 is an authentic representation of the reconstructed raw image data. More details regarding reconstructing and rendering an image in an authenticated image format are described below in connection with FIG. 3.

In some implementations, the output image file can include a digital signature based on both the processed image data 108 and the representation of the delta 126 between the decoded frame 122 and the raw image data 104. The joint signature can be based on the full content in the authenticated image format, i.e., based on both the processed image data 108 and the representation of the delta 126, and can ensure authenticity of the output image file 130. For example, a fraudulent modification can be applied to a digital signature of a portion of a conventional authenticated image format without being identified because the digital signature of a conventional authenticated image format is only based on either raw image data or processed image data. In contrast, a fraudulent modification cannot be applied to a digital signature of a portion of the authenticated image format because the digital signature of the authenticated image format is generated based on the full content in the authenticated image format. That is, the joint signature can ensure the whole content in the generated output 130 is authentic.

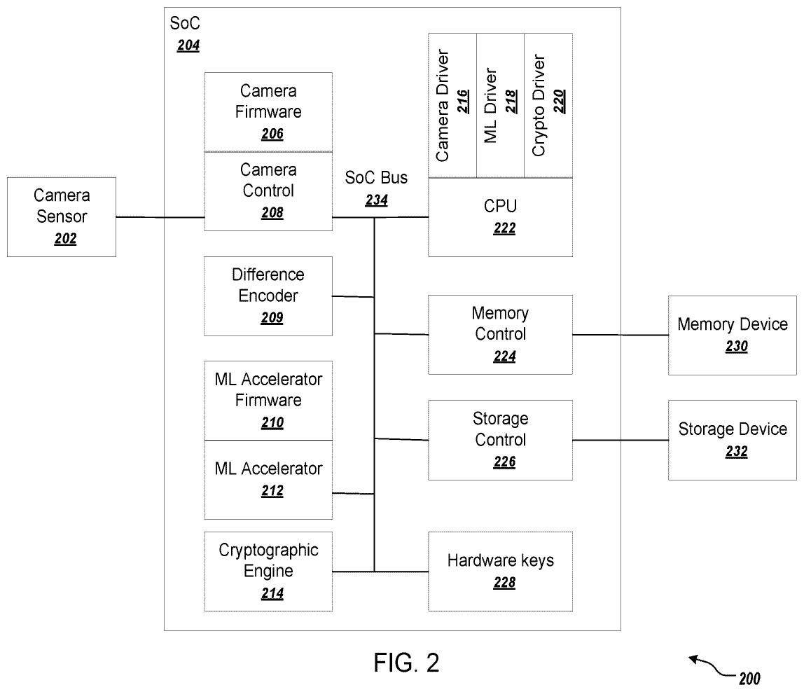

FIG. 2 is a diagram of an example computing device 200 that can generate a camera image in the authenticated image format. The computing device 200 includes a system on a chip (SoC) 204 that can generate an authentication image file, e.g., the output image file 130 in the authenticated image format. That is, generating the authentication image file can be performed on the device through a SoC 204. The FIG. 2 and its description are using SoC as an example device. However, the computing device 200 can be any generic processing device.

The SoC 204 includes a camera control 208 that interacts with a camera sensor 202 of the computing device 200. The camera control 208 is connected to the central processing unit (CPU) 222 of the SoC through a SoC bus 234. The camera control 208 can communicate with the camera driver 216 on the CPU 222. In some implementations, the SoC 204 can include a camera firmware 206 that can communicate with the camera driver 216 through the camera control 208.

The SoC 204 includes a ML accelerator 212. The ML accelerator 212 is connected to the CPU 222 through the SoC bus 234. A ML driver 218 can perform post-processing on an image captured by the camera sensor 202. The ML driver 218 can communicate with the ML accelerator 212 during the process of image post-processing in order to accelerate the one or more steps in the post-processing pipeline 106. In some implementations, the SoC 204 can include a ML accelerator firmware 210 that can communicate with the ML driver 218 through the ML accelerator 212.

The SoC 204 includes a cryptographic engine 214, which can be a software or hardware module that can generate a digital signature for a hash of data of interest. A cryptographic driver (crypto driver) 220 can communicate with the cryptographic engine 214 through the SoC bus 234. The crypto driver 220 can control the cryptographic engine 214 to generate a digital signature of the full content of the data in the authenticated image format, i.e., the processed image data 108 and the representation of the delta 126 between the decoded frame 122 of the processed image data 108 and the raw image data 104.

The cryptographic engine 214 can have access to the hardware keys 228 through the SoC bus 234. The hardware keys 228 can include a public-private key pair associated with the computing device 200. The public-private key pair can indicate whether the computing device 200 is trustworthy. The cryptographic engine 214 can generate the digital signature of the processed image data 108 and the representation of the delta 126 using a private key of the hardware keys 228 of the computing device 200. For example, the cryptographic engine 214 can generate the digital signature by encrypting a hash value of the processed image data 108 and the representation of the delta 126 using a private key of the hardware keys 228.

The SoC 204 includes a memory control 224 that controls a memory device 230 in the computing device 200. The memory control 224 is connected with the CPU 222 through the SoC bus 234. The memory device 230 can include both volatile and non-volatile memory, such as Random Access Memory (RAM) and Flash RAM. For example, after the camera sensor 202 captures raw image data 104, the raw image data 104 can be saved to a shared buffer in the memory device 230. The CPU can later access the raw image data 104 saved in the memory device 230 and perform post-processing on the raw image data 104 using the ML accelerator 212. The processed image data 108, and the representation of the delta 126 can also be saved in a shared buffer of the memory device 230 that is controlled by the memory control 224.

The SoC 204 includes a storage control 226 that controls storage device 232 in the computing device 200. The storage device 232 can include, for example, one or more of a hard disk device, an optical disk device, a solid state memory device, and so on. The storage control 226 is connected with the CPU 222 through the SoC bus 234. After the SoC 204 generates the output image file 130 in the authenticated image format, the output image file 130 can be saved to the storage device 232 that is controlled by the storage control 226.

Below is an example process of generating an authenticated image file on the computing device 200.

A camera application of the computing device 200 can trigger the camera sensor 202 to capture an image. The camera firmware 206 can communicate with the camera driver 216 on the CPU 222 to save the raw image data 104 to a shared buffer in the memory device 230.

The camera application can invoke an image post-processing component in the SoC 204 to perform post-processing on the raw image data to generate processed image data, e.g., generating a processed image using HDR+post-processing. For example, the camera application can invoke the ML driver 218 on the CPU 222 to perform post-processing on the raw image data 104 to generate processed image data 108. The CPU 222 can compare the processed image data 108 with the raw image data 104 to generate the difference, i.e., the delta between the decoded frame 122 of the processed image data 108 and the raw image data 104. In some implementations, the ML driver 218 can work with a ML accelerator firmware 210 to perform the image post-processing pipeline and to generate the delta between the two images.

The CPU 222 can perform a difference encoding using a difference encoder 209 to generate a compressed delta of the difference between the raw image data and the decoded frame of the post-processed image data. For example, the difference encoding can be entropy coding, Huffman coding, run-length encoding, and/or any other suitable technique. After generating the compressed delta, the CPU 222 can append the compressed delta to the processed image data.

The camera application can invoke the cryptographic driver 220 to control the cryptographic engine 214 to generate a digital signature of the processed image data 108 and a representation of the delta 126 between the decoded frame 122 of the processed image data 108 and the raw image data 104. In some implementations, the cryptographic engine 214 can have access to the hardware keys 228 of the computing device and can generate the digital signature using the private key of the hardware keys 228.

The camera application can generate an output image file 130 in an authenticated image format. The output image file 130 can include the processed image data 108 and the representation of the delta 126. The output image file 130 can further include the digital signature that is generated based on the processed image data 108 and the representation of the delta 126. The camera application can save the output image file 130 into the storage device 232.

FIG. 3 is a diagram of an example system 300 for rendering an image in an authenticated image format. The process of rendering the image in the authenticated image format can be implemented in an operation system of an image rendering computer, can be implemented as a part of a standalone image viewing or editing application of a computing device, or can be implemented as a part of a web browser software, and so on.

An image rendering computer 304 can receive input data 302 in an authenticated image format. The image rendering computer 304 can be a computer that is different from the computing device that generated the input data 302. As described in FIG. 1, the input data 302 in the authenticated image format can be the output image file 130 generated by an on-device image authentication process. The input data 302 can include processed image data 108 and a representation of a delta 126 between a decoded frame of the processed image data and raw image data.

The image rendering computer 304 can receive a request 306 to view the raw image included in the input data 302, e.g., from a user 316 of the image rendering computer 304.

For example, a vehicle owner can capture an image of a damaged vehicle using a mobile device. Because the image is captured at night, the mobile device might perform low-light correction and JPEG encoding, and can generate a processed encoded image of the raw image of the damaged vehicle. The mobile device can generate an image file in the authenticated image format that includes the low-light corrected processed and encoded image of the damaged vehicle and a representation of the delta between the processed image data and the raw image captured by the camera. The vehicle owner can upload the image file in the authenticated image format to a computer of an insurance company during a process of claiming coverage for the damage to the vehicle. The computer of the insurance company, i.e., the image rendering computer 304, can receive the uploaded image file in the authenticated image format. An insurance agent 316 can send a request to the computer to view the raw image included in the uploaded image file in the authenticated image format. For example, the insurance agent 316 may want to visually compare the raw image and the processed image to determine whether the post processed image is an authentic representation of the damaged vehicle. In some implementations, the insurance agent 316 can send a request to the computer and instruct the computer to verify the digital signature included in the uploaded image file.

Upon receiving the request to view the raw image 306, the image rendering computer 304 can generate a processed image 308 and a raw image 310 from the input data 302 in the authenticated image format. The image rendering computer 304 can generate the processed image 308 by reading the processed image included in the input data 302. The image rendering computer 304 can generate a decoded image of the processed image 308 by decoding the processed image using a decoder, e.g., the same as the decoder 120 during the generation of the input data 302. The image rendering computer 304 can generate the raw image 310 by combining the decoded image with the representation of the delta 126 that is included in the input data 302.

For example, a computer of the insurance company can generate a processed image of the damaged vehicle, e.g., a JPEG encoded image of the damaged vehicle, using a JPEG decoder that decodes a JPEG image. The computer can generate a raw image corresponding to the processed image by combining the representation of the delta 126 included in the input data 302 with the decoded image of the processing image 308.

The image rendering computer 304 can include a display device 314, such as a monitor of a desktop computer, a screen of the mobile device, a VR and/or AR equipment and so on. In some implementations, as shown in FIG. 3, the image rendering computer 304 can present the processed image 308 and the raw image 310 side by side on the display device 314. In some implementation, not currently shown in FIG. 3, the image rendering computer 304 can present a user interface element that enables a user 316 to toggle between the processed image 308 and the raw image 310. In some implementations, not currently shown in FIG. 3, the image rendering computer 304 can present a user interface element that displays a difference, e.g., a difference image, between the processed image 308 and the raw image 310. For example, the difference between two images can be calculated by finding the difference between each pixel in each image, and generating an image based on the difference between each pixel in each image.

In some implementations, the image rendering computer 304 can receive a request 306 to verify the digital signature included in the input data 302. In some implementations, the image rendering computer 304 can verify the digital signature before generating the raw image from the input data 302. If the verification of the digital signature is successful, the image rendering computer 304 can proceed to reconstruct the raw image from the input data 302 in the authenticated image format, and the image rendering computer 304 can notify the user 316 that the computing device that generated the input data 302 is a trustworthy device. If the verification of the digital signature is not successful, the image rendering computer 304 may not proceed to reconstruct the raw image, and the image rendering computer 304 can notify the user 316 that the computing device that generated the input data 302 is not a trustworthy device.

In some implementations, the image rendering computer 304 can display a device identity 312 on the display device 314. The device identity 312 can be included in a digital certificate along with the device public key. The digital certificate can be signed by a certification authority (CA) private key, e.g., through a sub-CA, at the device manufacturer. The device identity 312 can include an identification of the device that generated the input data 302, or the verification result of the digital signature, e.g., “Device Verified”, or “Device Not Verified”. A user 316 can review the digital signature verification result included in the device identity 312 and can determine whether the device that generated the input data 302 is trustworthy.

In some implementations, the image rendering computer 304 can include a generic image reader, e.g., a JPEG decoder, that is not specialized to process the input data 302 in the authenticated image format. The image rendering computer 304 can still decode and render the processed image, e.g., rendering the processed JPEG image as if it was just a normal JPEG image. In some implementations, the image rendering computer 304 can discard the rest of the data in the input data 302, e.g., discarding the representation of the delta between the decoded frame of the processed image and the raw image.

In some implementations, the image rendering computer 304 can receive input data that is not in the authenticated image format, e.g., a post-processed image in JPEG format. The image rendering computer 304 can still generate the post-processed image, e.g., by performing a JPEG decoding process, and displays the post-processed image on the displaying device 314, without generating a raw image 310. Therefore, the image rendering computer 304 is backward compatible to display an input data that is not in the authenticated image format.

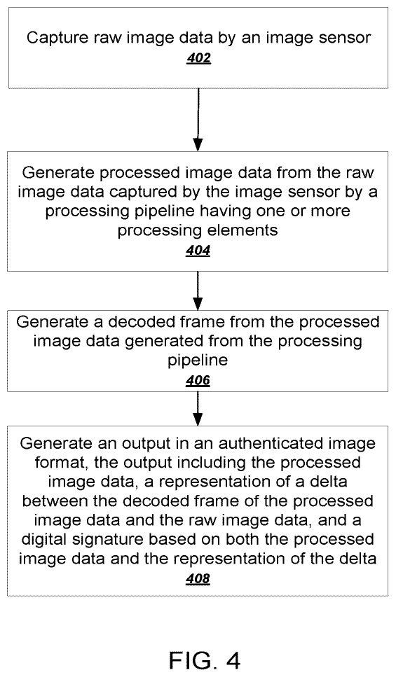

FIG. 4 is a flowchart of an example process for generating an output in an authenticated image format. For convenience, the process will be described as being performed by a system for generating an output image in an authenticated image format, for example, the system 100 in FIG. 1. The system can include the components of a computing device 200 described in reference to FIG. 2, including one or more camera sensors, one or more SoCs, one or more memory devices, and one or more storage devices, or some combination of these.

The system captures raw image data by an image sensor (402). In some implementations, the raw image data can include a single image of a single raw frame captured by a camera sensor. In some implementations, the raw image data can include a plurality of images of a sequence of raw frames captured by a camera sensor. The system can perform an alignment and merging processing to generate a single image as a raw image that represents what is being captured by the camera.

The system generates processed image data from the new image data captured by the image sensor by a processing pipeline having one or more processing elements (404). The processing pipeline can include one or more image processing routines or algorithms that can generate processed image data with improved image quality. The processed image data can include a processed image, or other format of processed data generated from the raw image data. In some implementations, the processed image can be in a compressed image format, e.g., JPEG, PNG, TIFF, or another compressed image format.

The system generates a decoded frame from the processed image data generated from the processed pipeline (406). In some implementations, the decoded frame can be in an uncompressed image format. For example, when the processed image is in JPEG format, the system can generate a decoded frame from the processed image using a JPEG image decoder.

The system generates an output in an authenticated image format (408). The output includes the processed image data and a representation of a delta between the decoded frame of the processed image data and the raw image data. That is, instead of saving the raw image data, the system generates the difference between the raw image data and the decoded frame of the processed image data. Then, the system encodes the difference in the output image in the authenticated image format, such that an image reader can later properly reconstruct the raw image data upon request.

The system can reliably generate and encode the raw image frame independently of the number and type of processing steps in the processing pipeline that is used to generate the processed image data. Later, an image reader that is configured to process the output file in the authenticated image format can reconstruct and display the raw image frame.

In some implementations, the representation of the delta between the decoded frame of the processed image data and the raw image data can be generated based on a compression algorithm that measures differences between image frames. The compression algorithm is efficient in processing the differences between image frames, e.g., the differences that have lots of zeros. When two image frames are sufficiently similar with each other, the difference between the two image frames can be compressed efficiently. For example, the system can generate the output using a video encoding algorithm that can encode the difference between frames in a video, such as a video MPEG encoder.

In some implementations, the output can include a digital signature based on both the processed image data and the representation of the delta between the decoded frame of the processed image data and the raw image data. That is, the system can sign and authenticate both the processed and encoded frame as well as the difference information, i.e., the delta between the decoded frame of the processed image data and the raw image data, in the same output file.

In some implementations, the system can generate a hash value based on the processed image data and the representation of the delta between the decoded frame of the processed image data and the raw image data, and the system can generate the digital signature based on the hash value. A hash value is a numerical value of a fixed length that uniquely identifies data. A hash value can represent a large amount of data as a much smaller numeric value.

In some implementations, the system can generate the digital signature by encrypting the hash value using a private key of a public-private key pair of the device. The system can have access to the hardware keys associated with the computing device of the system, e.g., the hardware keys 228 of the commuting device 200 in FIG. 2. The public-private key pair can indicate whether the computing device is trustworthy. Later, an image rendering computer can obtain a public key of the pair of private keys associated with the device and can verify the digital signature in the output file in the authenticated image format in order to determine whether the device that generated the output file is trustworthy.

In some implementations, the output can include a digital certificate that includes a public key of a public-private key pair of the device. In some implementations, the output can further include a device identifier, validity date, and a digital signature generated by a CA or a sub-CA. Later, an image rendering computer can verify the digital certificate in the output file in the authenticated image format using the public key in order to determine whether the device that generated the output file is trustworthy.

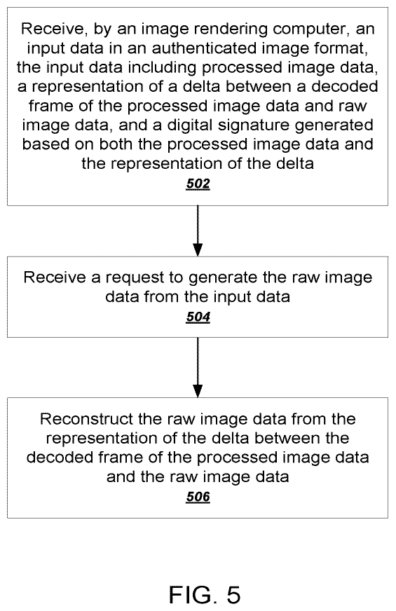

FIG. 5 is a flowchart of an example process for reconstructing raw image data from input data in an authenticated image format. For convenience, the process will be described as being performed by a system for image rendering, for example, the system 300 in FIG. 3. The system can include an image rendering computer or device that can be configured to parse the input data in the authenticated image format and reconstruct the raw image data from the input data in the authenticated image format.

The system receives input data in an authenticated image format (502). The input data includes processed image data and a representation of delta between a decoded frame of the processed image data and raw image data. The processed image data can include a processed image, or other format of processed data generated from the raw image data. For example, the input data can include a post-processed image in JPEG format and a delta between a decoded frame of the post-processed image and a raw image captured by a camera sensor.

The system receives a request to generate the raw image data from the input data (504). For example, the system can receive a request 306 from a user of the image rendering system to display the raw image 310 and the processed image 308, such that the user can verify the authenticity of the input data 302.

The system reconstructs the raw image data from the representation of the delta between the decoded frame of the processed image data and the raw image data (506). In some implementations, reconstructing the raw image data from the representation of the delta between the decoded frame of the processed image data and the raw image data can include generating the raw image data by combining the processed image data with the representation of the delta between the decoded frame of the processed image data and the raw image data.

In some implementations, the input data in the authenticated image format can include a digital signature generated based on the full content, i.e., both the processed image data and representation of the delta between the decoded frame of the processed image data and the raw image data. The digital signature generated on the full content can ensure the authenticity of the input data. That is, the digital signature can ensure that the processed image data and the representation of the delta cannot be modified after the digital signature is computed.

In some implementations, the digital signature included in the input data can be generated by (i) generating a hash value based on the processed image data and the representation of the delta between the decoded frame of the processed image data and the raw image data, and (ii) encrypting the hash value using a private key of a public-private key pair associated with a device that generates the input data in the authenticated image format. In some implementations, the public-private key pair can be hardware keys associated with the device that generated the input data, e.g., the hardware keys 228 of the computing device 200. The digital signature can indicate whether the input data was generated by a trustworthy device that is authorized to have access to the private key. In some implementations, the system can obtain a public key of the public-private key pair associated with the device that generates the input in the authenticated image format, and the system can verify the digital signature in the input data using the public key.

In some implementations, the input data in the authenticated image format can include a digital certificate that can be used to verify whether the input data was generated by a trustworthy device. The system can, before verifying the digital signature in the input data in the authenticated image format, verify the digital certificate in the input data, e.g., verifying that the input data was generated by a trustworthy device. Although any device can provide an authenticated image with a valid signature, only a legitimate device can have its device public key certified, e.g., by including the device public key in a valid digital certificate. An invalid device manufacturer cannot get its public key certified, e.g., by a CA or by a secure server.

In response to a successful verification of the digital certificate, the system can extract the device public key from the digital certificate. Then the system can proceed to verify the validity of the input data in the authenticated image format by verifying the digital signature using the device public key. If the input data is valid, the system can reconstruct the raw image data from the input data in the authenticated image format and display the reconstructed raw image to a user such that the user can determine whether the processed image is an accurate representation of the reconstructed raw image. In some implementations, the system can provide the reconstructed raw image and the processed image to a computer-implemented algorithm, e.g., a machine learning algorithm, and the algorithm can generate a matching score between the reconstructed raw image and the processed image, and the matching score can represent a likelihood that the processed image is an accurate representation of the reconstructed raw image.

In some implementations, the device public key can be provided in a digital certificate. The digital certificate can be certified by a certification authority (CA), and can be included in the input data in the authenticated image format. The digital certificate can be generated outside the device and can be provisioned in the device at the time of manufacturing. The device public key associated with a private key of the device can be certified by the CA. The system can verify the digital certificate included in the input data with a CA root public key in order to ensure the trustworthiness of the device that generated the input data in the authenticated image format. For example, the system can obtain the digital certificate by accessing metadata included in the input data, and the system can verify the digital certificate with a CA root public key.

In some implementations, the device public key can be stored in a trusted server or a trusted database that can be accessed by the system, and the system can obtain the device public key stored in the trusted server and can verify the digital signature in the input data using the device public key. For example, the system can retrieve the device public key stored in a trusted server based on an identification (ID) that is provided in the metadata of the input data. The system can verify the digital signature with the device public key retrieved from the trusted server.

In some implementations, the system can present the processed image data and the reconstructed raw image data side by side on a displaying device of the system. In some implementations, the system can present a user interface element that toggles between the processed image data and the reconstructed raw image data. For example, a user of the system can use the user interface element to toggle between the processed image and the reconstructed raw image.

In some implementations, the system or another system can take as input the processed image data and the reconstructed raw image data and generate a prediction result indicating whether the processed image data is an authentic representation of the reconstructed raw image data. In some implementations, the system or the other system can use a trained machine learning model to generate a prediction result indicating the likelihood that the processed image data is an authentic representation of the reconstructed raw image data.

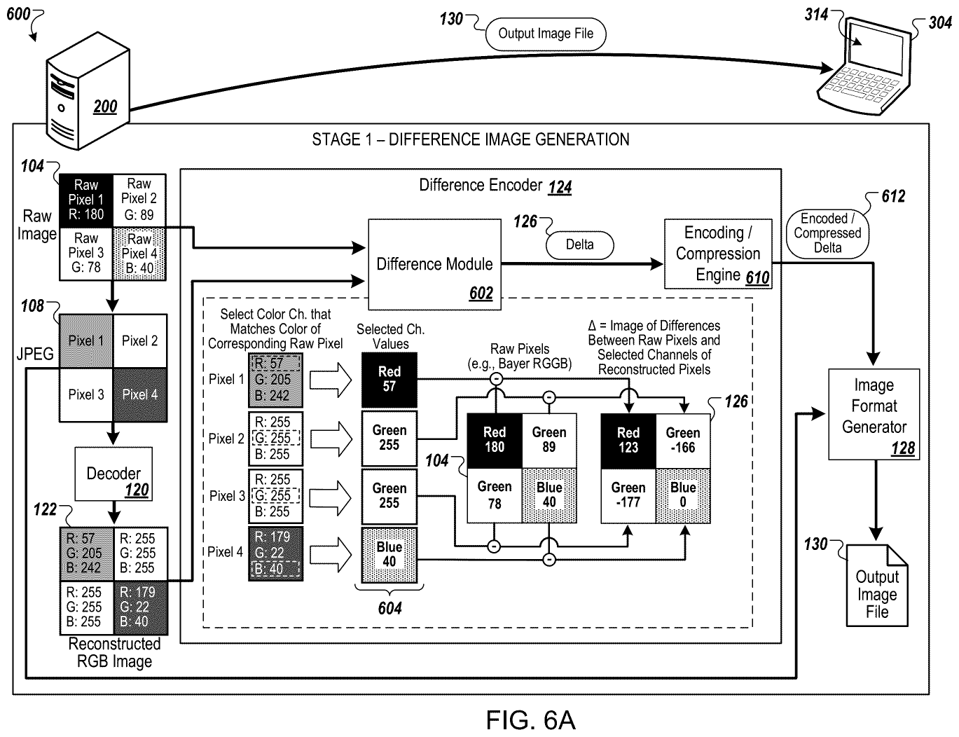

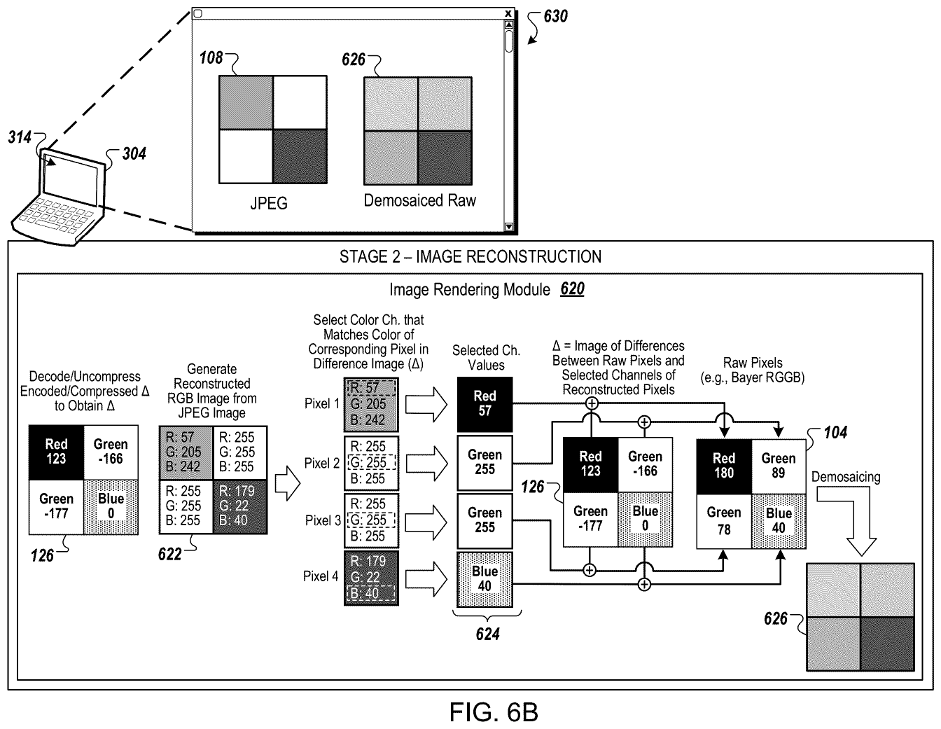

FIGS. 6A-6B are diagrams of an example system 600 for generating an output in an authenticated image format and reconstructing an earlier version of an image from the output.

FIG. 6A is a diagram of the example system 600 for generating an output in an authenticated image format. The system 600 can be the system 100 described above with respect to FIG. 1. The system 600 can include the computing device 200 described above with respect to FIG. 2 and the image rendering computer 304 with the display 314 described above with respect to FIG. 3.

The computing device 200 can be a computing device, such as a server, a desktop or laptop computer, a smart phone, a tablet computing device, a PDA, or the like.

The image rendering computer 304 can be a computing device, such as a server, a desktop or laptop computer, a smart phone, a tablet computing device, a PDA, or the like. The display 314 can be an integrated display such as an LED, OLED, LCD, or other display type screen of a laptop computer, a smart phone, a tablet computing device, a PDA, or the like. The display 314 can alternatively be an external display such as an LED, OLED, LCD, or other display type monitor electronically connected to a computing device.

The computing device 200 can communicate with the image rendering computer 304 over a network, such as a wireless network. For example, the computing device 200 can communicate with the image rendering computer 304 over a cellular network or the Internet.

The computing device 200 can generate the raw image data 104. For example, the computing device 200 can generate the raw image data 104 using the camera sensor 202 as described above with respect to FIG. 2. Alternatively, the computing device 200 can receive the raw image data 104 from a different device over a network.

The computing device 200 can generate the processed image data 108 from the raw image data 104 as described above with respect to FIG. 1. For example, the computing device 200 can convert the raw image data 104 to an image in a compressed image format having a smaller file size (e.g., JPEG image, PNG image, etc.) using the image processing pipeline described above with respect to FIG. 1.

Alternatively, the computing device 200 can receive the processed image data 108 from a different device over a network. For example, the computing device 200 can obtain both the raw image data 104 and the processed image data 108 from a smart phone that generated the raw image data 104 using a camera sensor and the processed image data 108 from the raw image data 104.

The raw image data 104 can be in a Bayer format. The raw image data 104 can be a Bayer RGGB image where groups of four pixels include an upper left pixel that is a red (R) color pixel, an upper right pixel that is a green (G) color pixel, a lower left pixel that is also a green (G) color pixel, and a lower right pixel that is a blue (B) color pixel. However, the raw image data 104 can be in a different format such as Bayer BGGR, Bayer RGBG, Bayer GRBG, or other formats of different colors and/or arrangements depending on the camera sensor used to generate the raw image data.

As an example, the raw image data 104 can include a grouping of four pixels. The group can include a red pixel (Raw Pixel 1) with a color intensity value 180 (e.g., 8-bit intensity value), a first green pixel (Raw Pixel 2) with a color intensity value of 89, a second green pixel (Raw Pixel 3) with a color intensity value of 78, and a blue pixel (Raw Pixel 4) with a color intensity value of 40. Although a simplified example of four pixels is shown and described, it should be understood that the raw image data 104 or a portion of the raw image data 104 used to generate the output image file 130 can include any number of pixels.

Although the example shown in FIG. 6A depicts use of 8-bit color (e.g., 8-bit RGB image size or depth) in both the raw image data 104 and in the decoded frame 122, various other scenarios are possible. For example, the raw image data 104 may have a color depth of 10-bit, 12-bit, 14-bit, or 16-bit. Typically, the decoded frame 122 will have an 8-bit RGB image size due to the processed image data 108 typically being a JPEG or PNG image that has an 8-bit color depth. However, the processed image data 108 and the decoded frame may have a different color depth, such as 10-bit or 12-bit. As described in more detail below, when the color depth of the raw image data 104 differs from that of the decoded frame 122, the difference encoder 124 may convert the lower bit pixel color intensity values of the decoded frame 122 to match the bit size of the raw image data 104 in order to generate the delta 126.

The raw image data 104 can represent all image data acquired from a camera sensor or a portion of the image data acquired from the camera sensor. For example, the raw image data 104 can be a frame selected from a video captured by the camera sensor.

The processed image data 108 can also be generated from all image data acquired from a camera sensor or from a portion of the image data acquired from the camera sensor. For example, where the raw image data 104 is a single frame from a video data object, the processed image data 108 can be generated by the computing device 200 using the same frame from the video data object. As another example, where the raw image data 104 includes the raw image data for an entire video data object such that it includes multiple image frames, the processed image data 108 can likewise include multiple image frames generated by the computing device 200 using the multiple frames of the raw image data 104.

The decoded frame 122 generated by the decoder 120 can represent all or a portion of the processed image data 108. As an example, where the processed image data 108 includes multiple images frames, the decoder 120 may select a particular frame from the processed image data 108 to use to generate the decoded frame 122. The decoder 120 may continually generate decoded frames from the processed image data 108, e.g., in response to generating a decoded frame, the difference encoder 124 obtaining the previously generated decoded frame, processing resources coming available, etc. The decoder 120 may continue to generate decoded frames until all frames of the processed image data 108 are converted into decoded frames. The computing device 200 can then provide (i) the decoded frame 122 that represents a portion of the processed image data 108 and (ii) the raw image data 104 or a corresponding portion of the raw image data 104 as input to the difference encoder 124.

The decoded frame 122 may represent all of the processed image data 108. For example, the decoded frame 122 can represent all of the processed image data 108 when the processed image data 108 includes a single image frame. Alternatively, the decoded frame 122 may include multiple image frames generated by the decoder 120 from multiple frames of the processed image data 108. The computing device 200 can then provide (i) the decoded frame 122 that represents all of the processed image data 108 and (ii) the raw image data 104 or a corresponding portion of the raw image data 104 as input to the difference encoder 124.

The decoded frame 122 can be a red-green-blue (RGB) reconstructed image. For example, the decoder 120 can convert processed image data 108 into an RGB image such that each pixel of the resulting decoded frame 122 has a red channel, a green channel, and a blue channel. Each channel of each pixel in the decoded frame 122 can have its own color or light intensity value. For example, Pixel 1 of the decoded frame 122 can include a red channel with a color intensity value of 57 out of 255 (e.g., 8-bit color depth), a green channel with a color intensity value of 205 out of 255, and a blue channel with a color intensity value of 242 out of 255.

The computing device 200 can provide the decoded frame 122 and the raw image data 104 or a portion of the raw image data 104 that corresponds to the decoded frame 122 as input to the difference encoder 124. The difference encoder can include a difference module 602 configured to generate the delta 126 from the decoded frame 122 and the raw image data 104 by calculating differences between selected channel intensity values 604 in the decoded frame 122 and corresponding intensity values in the raw image data 104. The difference module 602 can be a software module that includes one or more models for generating the delta 126. These one or more models can include a static or a machine learning model.

The difference module 602 can select color channels for the pixels in the decoded frame 122. For example, the difference module 602 can select a particular color channel for each pixel in the decoded frame 122.

The difference module 602 can use the raw image data 104 to determine what color channels to select for the different pixels in the decoded frame 122. For example, the difference module 602 can identify for each pixel in the decoded frame 122 a corresponding pixel in the raw image data 104 and determine a color (e.g., Bayer color filter) for the pixel in the raw image data 104. The difference module 602 can then select the color channel for that particular pixel in the decoded frame 122 that matches the color of the corresponding pixel in the raw image data 104. For example, based on Pixel 1 of the decoded frame 122 corresponding to the Raw Pixel 1 of the raw image data 104 that has a red color, the difference module 602 can select the red channel for the Pixel 1. The difference module 602 can similarly select the green channel for the Pixel 2 of the decoded frame 122, the green channel for the Pixel 3 of the decoded frame 122, and the blue channel for the Pixel 4 of the decoded frame 122 based on the colors of the corresponding pixels in the raw image data 104.

Using the techniques described above, the difference module 602 can obtain the selected channel intensity values 604 from the decoded frame 122. For example, the selected channel values can include a red color intensity value of 57 out of 255 for the Pixel 1 of the decoded frame 122, a green color intensity value of 255 out of 255 for the Pixel 2 of the decoded frame 122, a green color intensity value of 255 out of 255 for the Pixel 3 of the decoded frame 122, and a blue color intensity value of 40 out of 255 for the Pixel 4 of the decoded frame 122.

After obtaining the selected channel intensity values 604, the difference module 602 can calculate the delta 126 by taking differences between the color intensity values of the raw image data 104 (or portion of the raw image data 104) and corresponding values in the selected channel intensity values 604. For example, the difference module 602 can subtract the red color intensity value of 57 of Pixel 1 from the red color intensity value of 180 of Raw Pixel 1 of the raw image data 104 to calculate a color intensity value of 123 of the delta 126. The difference module 602 can similarly calculate the other intensity values of the delta 126.

In some implementations, when the color depth of the raw image data 104 does not match the color depth of the decoded frame 122, the difference module 602 changes a color depth of the decoded frame 122 or the selected channel intensity values 604 to match the color depth of the raw image data 104. For example, if the raw image data 104 uses a 12-bit color depth, the difference module 602 may convert the selected channel intensity values 604 from 8-bit to 12-bit by scaling the decoded frame 122 to a 12-bit size or multiplying the channel intensity values 604 by sixteen. The difference module 602 can then take a difference between the converted channel values and the corresponding 12-bit values in the raw image data 104 to generate the delta 126.

The delta 126 can be an image such as an RGB image or a gray scale image. For example, a first pixel of the delta 126 can be a pixel having a red channel with an intensity value of 123, a green channel with an intensity value of 0, and a blue channel with an intensity value of 0. Alternatively, the first pixel of the delta 126 can be a grayscale pixel with an intensity value of 123.

The difference module 602 can generate metadata for the delta 126. For example, the difference module 602 can generate metadata that indicates whether the light or color intensity values of the pixels in the delta 126 should be applied as positive and/or negative values during raw image reconstruction discussed in more detail below with respect to FIG. 6B. For example, the metadata may identify all pixels whose intensity value should be applied as a negative value.

The difference module 602 may alternatively indicate that the pixels of delta 126 include positive and/or negative values by adding a bit to each pixel value. For example, the difference module 602 may generate the delta 126 such that it has a 9-bit size or depth instead of an 8-bit size or depth, where the added bit indicates the sign of the pixel intensity values. For example, a ninth bit having the value of “0” can indicate that pixel include a positive value, whereas a ninth bit having the value of “1” can indicate that the pixel includes a negative value.

After generating the delta 126, the difference module 602 can provide the delta 126 to an encoding and compression engine 610 configured to encode and compress the delta 126. As an example, the encoding and compression engine 610 can partition the delta 126 into macroblocks of particular dimensions (e.g., 8×8 pixels, 16×16 pixels, 32×32 pixels, etc.). The engine 610 can, in some implementations, use half-pixel and/or quarter-pixel matching during partition.

After partitioning the delta 126, the engine 610 can, in some implementations, apply a discrete cosine transform (DCT), inverse DCT (IDCT), or another type of DCT.

After partitioning the delta 126, the engine 610 can, in some implementations, apply entropy encoding. For example, after partitioning the delta 126 and applying the DCT, the engine 610 can apply a Huffman entropy encoding to generate encoded and/or compressed delta 612.

After partitioning the delta 126, the engine can, in some implementations, apply run-length encoding. For example, after partitioning the delta 126, applying the DCT, and applying Huffman entropy encoding, the engine 610 can apply run-length encoding to generate the encoded and/or compressed delta 612.

After partitioning the delta 126, the engine 610 can apply one or more compression steps. For example, after partitioning the delta 126, applying the DCT, applying Huffman entropy encoding, and applying run-length encoding, the engine 610 can apply one or more compression steps to generate the encoded and/or compressed delta 612.

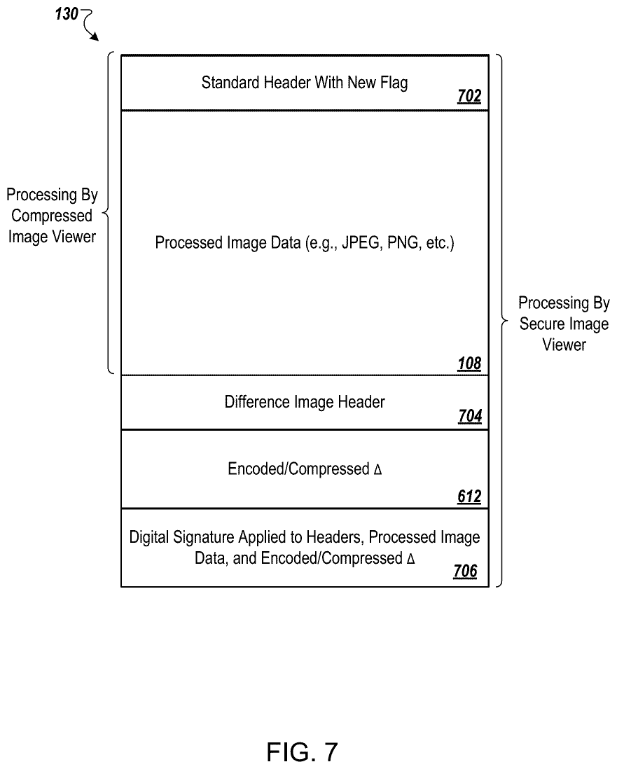

The engine 610 of the difference encoder 124 provides the encoded and/or compressed delta 612 as input to the image format generator 128. In response to receiving the encoded and/or compressed delta 612, the image format generator 128 generates the output image file 130 using the encoded and/or compressed delta 612 and processed image data 108 as described in more detail below with respect to FIG. 7. The output image file 130 can include the encoded and/or compressed delta 612 and the processed image data 108 such as an image in a compressed image format (e.g., JPEG format).

By encoding and/or compressing the delta 126 instead of, for example, the raw image data 104, more efficient compression can be achieved and the size of the output image file 130 can be comparatively reduced. For example, it is desirable for the output image file to contain the processed image data 108 that can be viewed by typical image viewers as described in more detail below with respect to FIG. 7. However, an output image file that includes both the processed image data 108 (e.g., JPEG) and the raw image data 104 would be very large. By instead calculating the delta 126 and including it in the output image file 130 after encoding and/or compression in place of the raw image data 104, the size of the output image file 130 can be significantly reduced while providing the ability to still reconstruct the raw image data 104 as described in more detail below with respect to FIG. 6B.

This is because the resulting encoded and/or compressed delta 612 would typically be smaller in size than the raw image data 104 or the raw image data 104 after being encoded and/or compressed. This is due, at least in part, to the differences between pixel intensity values in the raw image data 104 and the selected channels of the decoded frame 1222 (e.g., the reconstructed RGB image) usually being small, allowing for more efficient compression of the delta 126 compared to the raw image data 104.

FIG. 6B is a diagram of a part of the system 600 for reconstructing an earlier version of an image from received output in an authenticated image format. As described above, the system 600 includes the image rendering computer 304 that is configured to reconstruct an earlier version of an image from output in an authenticated image format and the display 314 that is used to present reconstructed image data next to the processed image data 108.

The image rendering computer 304 include can use an image rendering module 620 configured to reconstruct an earlier version of an image, such as the raw image data 104, from the output image file 130. The image rendering module 620 can be a software module that includes one or more models configured to perform the techniques described below and elsewhere, such as described above with respect to FIG. 3.

In response to receiving the output image file 130, the image rendering computer 304 can use the image rendering module 620 to decode and/or uncompress the encoded and/or compressed delta 612 in the output image file 130. For example, by decoding and uncompressing the data in the encoded and/or compressed delta 612, the image rendering module 620 can obtain the delta 126.

In response to receiving the output image file 130, the image rendering computer 304 can use the image rendering module 620 to generate a decoded frame 622 from the processed image data 108 in the output image file 130. For example, the computer 304 can also include a decoder that provides the functionality of the decoder 120 described above and use the decoder to generate a reconstructed RGB image from a compressed image in the output image file 130. The decoded frame 622 can be the same as the decoded frame 122 as shown.

In some implementations, the decoded frame 622 differs from the decoded frame 122. For example, the decoded frame 622 may differ from the decoded frame 122 based on differences in how the computer 304 generates decoded frames (e.g., RGB reconstruction methodology used). However, ideally, the computing device 200 and the computer 304 use the same methodology to, for example, generate reconstructed RGB images from the processed image data 108.

After generating the decoded frame 622, the image rendering module 620 can select color channels for the pixels in the decoded frame 622 to obtain selected channel intensity values 624. The process of selecting color channels for pixels of the decoded frame 622 to match colors of corresponding pixels in the delta 126 is described in more detail above with respect to the decoded frame 122 in FIG. 6A.

After obtaining the selected channel intensity values 624, the image rendering module 620 can add the selected channel intensity values 624 to the delta 126 to reconstruct the raw image data 104 or a portion of the raw image data 104. For example, the module 620 can add the red channel intensity value of 57 of Pixel 1 of the decoded frame 622 to an intensity value of 123 of a corresponding pixel in the delta 126 to reconstruct Raw Pixel 1 of the raw image data 104 which had a color intensity of 180. The module 620 can repeat the process for the other pixels of the decoded frame 622 and the delta 126 to reconstruct the Raw Pixel 2, the Raw Pixel 3, and the Raw Pixel 4 of the raw image data 104.

After reconstructing the raw image data 104 or a portion of the raw image data 104, the image rendering module 620 can perform demosaicing on the raw image data 104 or the portion of the raw image data 104 to generate a full color image 626. The full color image 626 is not mosaiced in that it does not contain the Bayer pattern image. Instead, each pixel of the full color image 626 can be a full color pixel such that the pixel has a red channel value, a green channel value, and a blue channel value. That is, the pixels in the full color image 626 are not limited to a single color channel or filter, unlike, for example, the raw image data 104.

In generating the full color image 626, the module 620 can apply a demosaicing algorithm. For example, the module 620 can generate the full color image 626 by interpolating the missing color channel values at all pixels of the raw image data 104. For example, through interpolation, the module 620 can generate a green channel value and a blue channel value for the Raw Pixel 1 of the raw image data 104 that only contains a red color intensity value. The demosaicing algorithm can be, for example, linear interpolation, bilinear interpolation, bicubic interpolation, a homogeneity directed demosaicing algorithm, higher order interpolation, or the like.

After generating the full color image 626, the computer 304 can present the full color image 626 on an interface 630 of the display 314. For example, the computer 304 can present the full color image 626 next to the processed image data 108. By presenting the full color image 626 next to the processed image data 108, a user of the computer 304 can easily identify differences between the processed image data 108 and the raw image data 104 represented by the full color image 626. The full color image 626 can serve as a ground truth frame that is independent of the potentially multiple and type of finishing steps performed on the image to generated the processed image data 108. In this way, the user of the computer 304 can quickly identify edits that another user made to an image or that a device automatically made to an image in, for example, applying a filter or enhancing image (e.g., low-light correction).

As an example, the image rendering computer 304 can first present the processed image data 108 from the output image file 130 on the interface 630. After presenting the processed image data 108, the computer 304 can present the full color image 626 in response to receiving a request from the user to view the raw image data 104.

For example, a vehicle owner can capture an image of a damaged vehicle using a camera of the computing device 200. Because the image is captured at night, the computing device 200 might perform low-light correction and JPEG encoding, and can generate a processed encoded image of the raw image of the damaged vehicle. The computing device 200 can generate an image file in the authenticated image format that includes the low-light corrected processed and encoded image of the damaged vehicle and a representation of the delta between the processed image data and the raw image captured by the camera of computing device 200. The vehicle owner can upload the image file in the authenticated image format to a computer of an insurance company during a process of claiming coverage for the damage to the vehicle. The computer of the insurance company, e.g., the image rendering computer 304, can receive the uploaded image file in the authenticated image format. A user of the computer 304 (e.g., the insurance agent 316 as described above with respect to FIG. 3) can send a request to the computer 304 to view the raw image included in the uploaded image file in the authenticated image format. For example, the insurance agent 316 may want to visually compare the raw image and the processed image to determine whether the post processed image is an authentic representation of the damaged vehicle. In some implementations, the insurance agent 316 can send a request to the computer 304 and instruct the computer 304 to verify the digital signature included in the uploaded image file.

In some implementations, the computer 304 also or alternatively displays the delta 126 or a representation of the delta 126 on the interface 630. For example, the computer 304 may perform demosaicing on the delta 126 to generate a full color image of the differences and, afterwards, display the full color image of the differences on the interface 630.

FIG. 7 is a diagram illustrating an example authenticated image format of the output image file 130. The authenticated image format can specify that the output image file 130 includes a standard header 702 with a new flag, the processed image data 108, a difference image header 704 for the encoded and/or compressed delta 612, the encoded and/or compressed delta 612, and a digital signature 706 applied to the standard header 702, the processed image data 108, the header 704, and the encoded and/or compressed delta 612.

The standard header 702 can be a standard image header for the processed image data 108 with a new flag added to the standard image header to indicate the presence of the additional image data (e.g., the encoded and/or compressed delta 612). The flag can indicate that the additional image data appears after the processed image data 108 in the output image file 130.

The authenticated image format can specify that difference image data is appended to an output image file after the compressed image data. For example, the authenticated image format can specify that the encoded and/or compressed delta 612 is appended to the output image file 130 after the processed image data 108.

The header 704 can, in some implementations, indicate the encoding used to generate the difference image data. For example, the header 704 can indicate that the Huffman entropy encoding was used to generate the encoded and/or compressed delta 612. The computer 304 can identify a type of encoding performed on the difference image data from the header 704 and use this information to decode the encoded and/or compressed delta 612.

The header 704 can, in some implementations, indicate the compression used to generate the difference image data. For example, the header 704 can indicate the type of compression used to generate the encoded and/or compressed delta 612. The computer 304 can identify a type of compression performed on the difference image data from the header 704 and use this information to uncompress the encoded and/or compressed delta 612.

The authenticated image format can be backwards compatible to allow legacy image readers to read and/or present processed image data in outputs image files that are in the authenticated image format. For example, the standard header 702 and processed image data 108 can be processed by a standard or legacy compressed image viewer. In more detail, where the processed image data 108 is a compressed image such as a JPEG, the authenticated image format allows a standard JPEG viewer to read the standard header 702 while ignoring the new flag and present the processed image data 108 on a display interface. However, this standard JPEG viewer would not, for example, be capable of processing the header 704 and the encoded and/or compressed delta 612. Accordingly, the standard JPEG viewer in this example would not be able to reconstruct the raw image data 104 from the processed image data 108 and the encoded and/or compressed delta 612.

A secure or specialized image viewer may be configured to process the entirety of the output image file 130 in the authenticated image format. For example, the secure image viewer can be installed on the computer 304 described above or may be accessed by the computer 304 through a web browser and used by the computer 304 to extract the encoded and/or compressed delta 612 from the output image file 130. The secure image viewer may also be used for additional functions, such as the functions of the module 620 described above.

As an example, when opening the output image file 130, the secure image viewer can recognize the new flag in the standard header 702 and use it to determine that the output image file 130 contains difference image data (e.g., the encoded and/or compressed delta 612). The secure image viewer can read the header 704 and use the information in the header 704 to obtain the difference image data, present the difference image data, reconstruct the raw image data 104 from the difference image data and the processed image data 108, and/or generate a full color image from the reconstructed raw image data.

The secure image viewer can also perform the functions of a legacy or standard image viewer as described above. For example, the secure image viewer can read the standard header 702 and use the information in the standard header 702 to present the processed image data 108.

The authenticated image format can feature joint attestation. For example, hashing and signature can be performed on the entire data bundle containing the standard header 702, the processed image data 108, the header 704, and the encoded and/or compressed delta 612. The resulting digital signature 706 can be included in the output image file 130 in accordance with the authenticated image format and used by the computer 304 to authenticate the output image file 130.

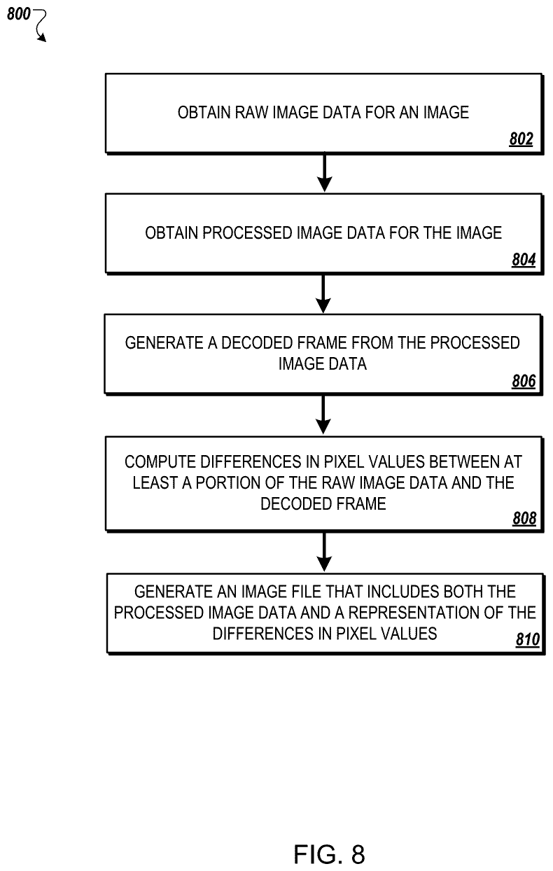

FIG. 8 is a flowchart of an example process 800 for generating an output in an authenticated image format. The process 800 can be performed by the system 100 described above. The process 800 can be performed by the system 600 described above with respect to FIGS. 6A-6B. For example, the process 800 can be performed by the computing device 200 described above with respect to FIG. 2 and FIGS. 6A-6B.

The process 800 includes obtaining raw image data for an image (802). For example, the computing device 200 can obtain the raw image data 104 from an onboard camera sensor or from an external device over a wireless network. The raw image data 104 can be a Bayer image format such as Bayer RGGB.

The process 800 includes obtaining processed image data for the image (804). For example, the computing device 200 can generate the processed image data 108 from the raw image data 104. Alternatively, the computing device 200 can obtain the processed image data from an external device over a wireless network. The processed image data can be, for example, a JPEG file, a PNG file, or another image file in a compressed and/or encoded image format.

In some implementations, the processed image data is encoded image data. For example, the processed image data 108 can be generated by encoding the raw image data 104 as shown in FIG. 6A.

In some implementations, the processed image data is compressed image data. For example, the processed image data 108 can be generated by compressing the raw image data 104 as shown in FIG. 6A.

In some implementations, the processed image data is encoded and compressed image data. For example, the processed image data 108 can be generated by encoding and compressing the raw image data 104 as shown in FIG. 6A.

The process 800 includes generating a decoded frame from the processed image data (806). For example, with respect to FIG. 1 and FIG. 6A, the computing device 200 can generate the decoded frame 122 from a processed image such as the processed image data 108 using the decoder 120. The decoded frame can be a red-green-blue (RGB) reconstructed image such that each pixel in the decoded frame can have three color channels, a red channel with a red color intensity value, a green channel with a green color intensity value, and a blue channel with a blue color intensity value. The decoded frame can be generated from the entire processed image data such that decoded frame and the processed image data share the same number of pixels. Alternatively, the decoded frame can be generated from a portion of the processed image data.

The process 800 includes computing differences in pixel values between at least a portion of the raw image data and the decoded frame (808). For example, with respect to FIG. 1 and FIG. 6A, the computing device 200 can use a difference module 602 of the difference encoder 124 to compute differences between the decoded frame 122 and at least a portion of the raw image data 104. Each pixel in the decoded frame can have a corresponding pixel in the at least portion of the raw image data such that the number of pixels in the decoded frame can equal the number of pixels in the at least portion of the raw image data.

In some implementations, the at least portion of the raw image data includes all of the raw image data. This can be the case, for example, when the decoded frame is generated using the entirety of the processed image data.

In some implementations, that at least portion of the raw image data includes a portion of the raw image data. This can be the case, for example, when the decoded frame is generated using a portion of the processed image data.

In some implementations, computing differences in the pixel values includes, for each pixel in the decoded frame, identifying a color channel of the pixel that matches a color of a corresponding pixel in the at least portion of the raw image data; and, for each pixel in the decoded frame, discarding the other color channels that did not match the color of the corresponding pixel in the at least portion of the raw image data such that the pixel contains a single color channel. For example, with respect to FIG. 6A, the computing device 200 can use the difference module 602 to select a particular color channel for each of the pixels in the decoded frame 122 based on colors of corresponding pixels in the raw image data 104 to obtain the selected channel intensity values 604.

In some implementations, computing differences in pixel values between the at least portion of the raw image data and the decoded frame includes identifying, for each pixel in the at least portion of the raw image data, a value for the pixel and a second value for a corresponding pixel in the decoded frame; and taking, for each pixel in the at least portion of the raw image data, a difference between the value and the second value. For example, with respect to FIG. 6A, the computing device 200 can use the difference module 602 to generate a difference image (e.g., the delta 126) by subtracting the values in the selected channel intensity values 604 for the pixels in the decoded frame 122 from corresponding color intensity values of the at least portion of the raw image data 104.

In some implementations, wherein computing differences in pixel values between the at least portion of the raw image data and the decoded frame includes identifying a scale of the at least portion of the raw image data; and scaling the decoded frame to the scale of the at least portion of the raw image data. Identifying, for each pixel in the at least portion of the raw image data, the value for the pixel and the second value for the corresponding pixel in the decoded frame can include identifying, for each pixel in the at least portion of the raw image data, the value for the pixel and the second value for the corresponding pixel in the decoded frame after the decoded frame is scaled.

For example, with respect to FIG. 6A, the difference module 602 of the computing device 200 can scale the decoded frame 122 or the values in the selected channel intensity values 604 to a scale of the raw image data 104. In more detail, if the raw image data 104 is in a 12-bit scale or color depth, the difference module 602 can, for example, convert the values in the selected channel intensity values 604 from an 8-bit scale or color depth to the 12-bit scale or color depth by multiplying them by sixteen.

In some implementations, the value for the pixel and the second value for the corresponding pixel are values representing color intensities. For example, with respect to FIG. 6A, the value 57 for the red channel of Pixel 1 of the decoded frame can represent a red color intensity of 57 out of 255 on an 8-bit scale.

The process 800 includes generating an image file that includes both the processed image data and a representation of the differences in pixel values (810). For example, with respect to FIG. 6A, the computing device 200 can use the encoding and compression engine 610 of the difference encoder 124 to encode and/or compress the differences in pixel values (e.g., the delta 126). The computing device 200 can then use an image format generator 128 to generate the output image file 130 from the resulting encoded and/or compressed delta 612 and the processed image data 108.

In some implementations, generating an image file that includes both the processed image data and a representation of the differences in pixel values includes encoding and compressing the differences in pixel values. For example, with respect to FIG. 6A, the computing device 200 can the encoding and compression engine 610 of the difference encoder 124 to encode the differences in pixel values (e.g., the delta 126) and then apply one or more compression steps to the encoded differences in pixel values. Applying coding can include the engine 610 applying entropy encoding and/or run-length encoding.

In some implementations, the representation of the differences in pixel values is the encoded and compressed differences in pixel values. For example, as shown in FIG. 7, the output image file 130 can include the encoded and/or compressed delta 612.

In some implementations, the differences in pixel values is a difference image, and encoding and compressing the differences in pixel values includes partitioning the difference image into one or more macroblocks, encoding the partitioned image to generated an encoded image, and compressing the encoded image to generate an encoded and compressed image. For example, with respect to FIG. 6A, the engine 610 of the computing device 200 can partition the delta 126 (e.g., a difference image) into multiple 8×8 pixel macroblocks, apply Huffman entropy encoding to the partitioned difference image, and apply one or more compression steps to the encoded image.

In some implementations, generating the image file includes generating a digital signature using the processed image data and the representation of the differences in pixel values, and the image file includes the digital signature. For example, with respect to FIG. 7, the output image file 130 can include the digital signature 706 that is applied to the processed image data 108, the difference image data (e.g., the encoded and/or compressed delta 612), to the standard header 702, and to the header 704.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

A computer program, which may also be referred to or described as a program, software, a software application, an app, a module, a software module, an engine, a script, or code, can be written in any form of programming language, including compiled or interpreted languages, or declarative or procedural languages; and it can be deployed in any form, including as a stand-alone program or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

To provide for interaction with a user, embodiments of the subject matter described in this specification can be implemented on, or configured to communicate with, a computer having a display device, e.g., a LCD (liquid crystal display) monitor, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client device having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a computer-implemented method, comprising:
obtaining raw image data for an image;
obtaining processed image data for the image;
generating a decoded frame from the processed image data;
computing differences in pixel values between at least a portion of the raw image data and the decoded frame; and
generating an image file that includes both the processed image data and a representation of the differences in pixel values.

Embodiment 2 is the method of embodiment 1, wherein generating the decoded frame from the processed image data comprises:
identifying a frame in the processed image data; and
reconstructing a red, green, blue (RGB) frame from the frame, wherein the RGB frame is the decoded frame.

Embodiment 3 is the method of embodiment 2, wherein the RGB frame includes a set of color channels for each pixel in the RGB frame, and
wherein computing differences in the pixel values comprises:
   for each pixel in the RGB frame, identifying a color channel of the pixel that matches a color of a corresponding pixel in the at least portion of the raw image data; and
   for each pixel in the RGB frame, discarding the other color channels that did not match the color of the corresponding pixel in the at least portion of the raw image data such that the pixel contains a single color channel.

Embodiment 4 is the method of any one of embodiments 1-3, wherein computing differences in pixel values between the at least portion of the raw image data and the decoded frame comprises:
identifying, for each pixel in the at least portion of the raw image data, a value for the pixel and a second value for a corresponding pixel in the decoded frame; and
taking, for each pixel in the at least portion of the raw image data, a difference between the value and the second value.

Embodiment 5 is the method of embodiment 4, wherein computing differences in pixel values between the at least portion of the raw image data and the decoded frame comprises:
identifying a scale of the at least portion of the raw image data; and
scaling the decoded frame to the scale of the at least portion of the raw image data,
wherein identifying, for each pixel in the at least portion of the raw image data, the value for the pixel and the second value for the corresponding pixel in the decoded frame comprises identifying, for each pixel in the at least portion of the raw image data, the value for the pixel and the second value for the corresponding pixel in the decoded frame after the decoded frame is scaled.

Embodiment 6 is the method of any one of embodiments 4-5, wherein the value for the pixel and the second value for the corresponding pixel are values representing color intensities.

Embodiment 7 is the method of any one of embodiments 1-6, wherein generating an image file that includes both the processed image data and a representation of the differences in pixel values comprises encoding and compressing the differences in pixel values.

Embodiment 8 is the method of embodiment 7, wherein the representation of the differences in pixel values is the encoded and compressed differences in pixel values.

Embodiment 9 is the method of any one of embodiments 8-9, wherein the differences in pixel values is a difference image, and
wherein encoding and compressing the differences in pixel values comprises:
   partitioning the difference image into one or more macroblocks;
   encoding the partitioned image to generated an encoded image; and
   compressing the encoded image to generate an encoded and compressed image.

Embodiment 10 is the method of any one of embodiments 1-9, wherein generating the image file comprises generating a digital signature using the processed image data and the representation of the differences in pixel values, and wherein the image file includes the digital signature.

Embodiment 11 is a system comprising one or more computers; and one or more computer-readable media storing instructions that, when executed, cause the one or more computers to perform the method of any one of embodiments 1-10.

Embodiment 12 is one or more non-transitory computer-readable media storing instructions that, when executed by one or more computers, cause the one or more computers to perform the method of any one of embodiments 1-10.

While this specification contains many specific implementation details, these should not be construed as limitations on the scope of any invention or on the scope of what is being or may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

What is claimed is:

1. A computer-implemented method, comprising:
obtaining raw image data for an image;
obtaining processed image data for the image;
generating a decoded frame from the processed image data;
computing differences in pixel values between at least a portion of the raw image data and the decoded frame; and
generating an image file that includes both the processed image data and a representation of the differences in pixel values.

2. The method of claim 1, wherein generating the decoded frame from the processed image data comprises:
identifying a frame in the processed image data; and
reconstructing a red, green, blue (RGB) frame from the frame, wherein the RGB frame is the decoded frame.

3. The method of claim 2, wherein the RGB frame includes a set of color channels for each pixel in the RGB frame, and
wherein computing differences in the pixel values comprises:
for each pixel in the RGB frame, identifying a color channel of the pixel that matches a color of a corresponding pixel in the at least portion of the raw image data; and
for each pixel in the RGB frame, discarding the other color channels that did not match the color of the corresponding pixel in the at least portion of the raw image data such that the pixel contains a single color channel.

4. The method of claim 1, wherein computing differences in pixel values between the at least portion of the raw image data and the decoded frame comprises:
identifying, for each pixel in the at least portion of the raw image data, a value for the pixel and a second value for a corresponding pixel in the decoded frame; and
taking, for each pixel in the at least portion of the raw image data, a difference between the value and the second value.

5. The method of claim 4, wherein computing differences in pixel values between the at least portion of the raw image data and the decoded frame comprises:
identifying a scale of the at least portion of the raw image data; and
scaling the decoded frame to the scale of the at least portion of the raw image data,
wherein identifying, for each pixel in the at least portion of the raw image data, the value for the pixel and the second value for the corresponding pixel in the decoded frame comprises identifying, for each pixel in the at least portion of the raw image data, the value for the pixel and the second value for the corresponding pixel in the decoded frame after the decoded frame is scaled.

6. The method of claim 4, wherein the value for the pixel and the second value for the corresponding pixel are values representing color intensities.

7. The method of claim 1, wherein generating an image file that includes both the processed image data and a representation of the differences in pixel values comprises encoding and compressing the differences in pixel values.

8. The method of claim 7, wherein the representation of the differences in pixel values is the encoded and compressed differences in pixel values.

9. The method of claim 7, wherein the differences in pixel values is a difference image, and
wherein encoding and compressing the differences in pixel values comprises:
partitioning the difference image into one or more macroblocks;
encoding the partitioned image to generate an encoded image; and
compressing the encoded image to generate an encoded and compressed image.

10. The method of claim 1, wherein generating the image file comprises:
generating a digital signature using the processed image data and the representation of the differences in pixel values, and
wherein the image file includes the digital signature.

11. A system comprising:
one or more computers; and
one or more computer-readable media storing instructions that, when executed, cause the one or more computers to perform operations comprising:
obtaining raw image data for an image;
obtaining processed image data for the image;
generating a decoded frame from the processed image data;
computing differences in pixel values between at least a portion of the raw image data and the decoded frame; and
generating an image file that includes both the processed image data and a representation of the differences in pixel values.

12. The system of claim 11, wherein generating the decoded frame from the processed image data comprises:
identifying a frame in the processed image data; and
reconstructing a red, green, blue (RGB) frame from the frame, wherein the RGB frame is the decoded frame.

13. The system of claim 12, wherein the RGB frame includes a set of color channels for each pixel in the RGB frame, and
wherein computing differences in the pixel values comprises:
for each pixel in the RGB frame, identifying a color channel of the pixel that matches a color of a corresponding pixel in the at least portion of the raw image data; and
for each pixel in the RGB frame, discarding the other color channels that did not match the color of the corresponding pixel in the at least portion of the raw image data such that the pixel contains a single color channel.

14. The system of claim 11, wherein computing differences in pixel values between the at least portion of the raw image data and the decoded frame comprises:
identifying, for each pixel in the at least portion of the raw image data, a value for the pixel and a second value for a corresponding pixel in the decoded frame; and
taking, for each pixel in the at least portion of the raw image data, a difference between the value and the second value.

15. The system of claim 14, wherein computing differences in pixel values between the at least portion of the raw image data and the decoded frame comprises:
identifying a scale of the at least portion of the raw image data; and
scaling the decoded frame to the scale of the at least portion of the raw image data,
wherein identifying, for each pixel in the at least portion of the raw image data, the value for the pixel and the second value for the corresponding pixel in the decoded frame comprises:
identifying, for each pixel in the at least portion of the raw image data, the value for the pixel and the second value for the corresponding pixel in the decoded frame after the decoded frame is scaled.

16. The system of claim 14, wherein the value for the pixel and the second value for the corresponding pixel are values representing color intensities.

17. The system of claim 11, wherein generating an image file that includes both the processed image data and a representation of the differences in pixel values comprises:
encoding and compressing the differences in pixel values.

18. The system of claim 17, wherein the representation of the differences in pixel values is the encoded and compressed differences in pixel values.

19. The system of claim 17, wherein the differences in pixel values is a difference image, and
wherein encoding and compressing the differences in pixel values comprises:
partitioning the difference image into one or more macroblocks;
encoding the partitioned image to generate an encoded image; and
compressing the encoded image to generate an encoded and compressed image.

20. One or more non-transitory computer-readable media storing instructions that, when executed by one or more computers, cause the one or more computers to perform operations comprising:
obtaining raw image data for an image;
obtaining processed image data for the image;
generating a decoded frame from the processed image data;
computing differences in pixel values between at least a portion of the raw image data and the decoded frame; and
generating an image file that includes both the processed image data and a representation of the differences in pixel values.
